(19) United States
(12) Patent Application Publication
(10) Pub. No.: US 2005/0160011 A1
(43) Pub. Date: Jul. 21, 2005

(54) Method for concurrently employing differing materials to form a layer on a substrate

(75) Inventors: Sidlgata V. Sreenivasan, Austin, TX (US); Van N. Truskett, Austin, TX (US)

Correspondence Address: MOLECULAR IMPRINTS, INC.;KENNETH C. BROOKS, PO BOX 81536, AUSTIN, TX, 78708-1536, US

(73) Assignee: MOLECULAR IMPRINTS, INC., Austin, TX (US)

(21) Appl. No.: 10/760,821

(22) Filed: Jan. 20, 2004

(51) Int. Cl. G06F 17/60

(52) U.S. Cl. 705/26

(57) ABSTRACT

The present invention is directed to a method of forming a layer on a substrate, comprising forming a plurality of flowable regions on the substrate, with a first subset of the plurality of flowable regions comprising a first composition and a second subset of the plurality of flowable regions including a second composition differing from the first composition. A surface of the first and second subsets is provided with a desired shape and/or each of the areas of the substrate covered by the flowable regions may be provided with a desired shape. Thereafter, the desired shaped is recorded by solidifying the first and second subsets of the plurality of flowable regions.

### BACKGROUND OF THE INVENTION

The field of invention relates generally to imprint lithography. More particularly, the present invention is directed to deposition of materials on substrate during imprint lithography processes.

Micro-fabrication involves the fabrication of very small structures, e.g., having features on the order of micro-meters or smaller. Various examples of micro-fabrication are currently recognized.

U.S. Pat. No. 6,334,960 to Willson et al. and by Chou et al. in Ultrafast and Direct Imprint of Nanostructures in Silicon, Nature, Col. 417, pp. 835-837, June 2002 both disclose examples of microfabrication techniques. Both of these processes involve the use of forming a layer on a substrate by embossing a flowable material with a mold and subsequently solidifying the flowable material to form a patterned layer. Both of these processes, however, teach patterning of a single layer the entire extent of which is formed from a common material.

Thus, a need exists for providing improved process and diagnostic techniques for use with micro-fabrication processes, such as imprint lithography.

### SUMMARY OF THE INVENTION

The present invention is directed to a method of forming a layer on a substrate, comprising forming a plurality of flowable regions on the substrate, with a first subset of the plurality of flowable regions comprising a first composition and a second subset of the plurality of flowable regions including a second composition differing from the first composition. A surface of the first and second subsets is provided with a desired shape and/or each of the areas of the substrate covered by the flowable regions may be provided with a desired shape. Thereafter, the desired shaped is recorded by solidifying the first and second subsets of the plurality of flowable regions. These and other embodiments are discussed more fully below.

### BRIEF DESCRIPTION OF THE DRAWINGS

FIG. 1 is a perspective view of a lithographic system in accordance with the present invention;

FIG. 2 is a simplified elevation view of a lithographic system shown in FIG. 1;

FIG. 3 is a simplified representation of material from which an imprinting layer, shown in FIG. 2, is comprised before being polymerized and cross-linked;

FIG. 4 is a simplified representation of cross-linked polymer material into which the material shown in FIG. 3 is transformed after being subjected to radiation;

FIG. 5 is a simplified elevation view of a mold spaced-apart from the imprinting layer, shown in FIG. 1, after patterning of the imprinting layer;

FIG. 6 is a simplified elevational view of the template shown above in FIGS. 1 and 2, in accordance with the present invention;

FIG. 7 is a simplified elevational view of a dispensing system shown in FIG. 1, in accordance with the present invention; and

FIG. 8 is flow chart showing a process for dispensing fluids on a substrate in accordance with the present invention.

### DETAILED DESCRIPTION OF THE INVENTION

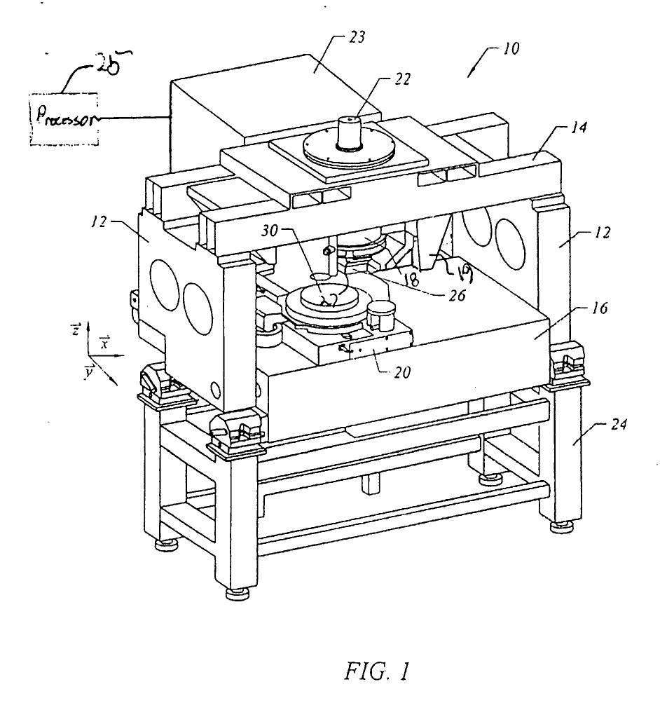

FIG. 1 depicts a lithographic system 10 in accordance with one embodiment of the present invention that includes a pair of spaced-apart bridge supports 12 having a bridge 14 and a stage support 16 extending therebetween. Bridge 14 and stage support 16 are spaced-apart. Coupled to bridge 14 is an imprint head 18, which extends from bridge 14 toward stage support 16 and provides movement along the Z-axis. Disposed upon stage support 16 to face imprint head 18 is a motion stage 20. Motion stage 20 is configured to move with respect to stage support 16 along X- and Y-axes. It should be understood that imprint head 18 may provide movement along the X- and Y-axes, as well as the Z-axis, and motion stage 20 may provide movement in the Z-axis, as well as the X- and Y-axes. An exemplary motion stage device is disclosed in U.S. patent application Ser. No. 10/194,414, filed Jul. 11, 2002, entitled “Step and Repeat Imprint Lithography Systems,” assigned to the assignee of the present invention, and which is incorporated by reference herein in its entirety. A radiation source 22 is coupled to lithographic system 10 to impinge actinic radiation upon motion stage 20. As shown, radiation source 22 is coupled to bridge 14 and includes a power generator 23 connected to radiation source 22. Operation of lithographic system 10 is typically controlled by a processor 25 that is in data communication therewith.

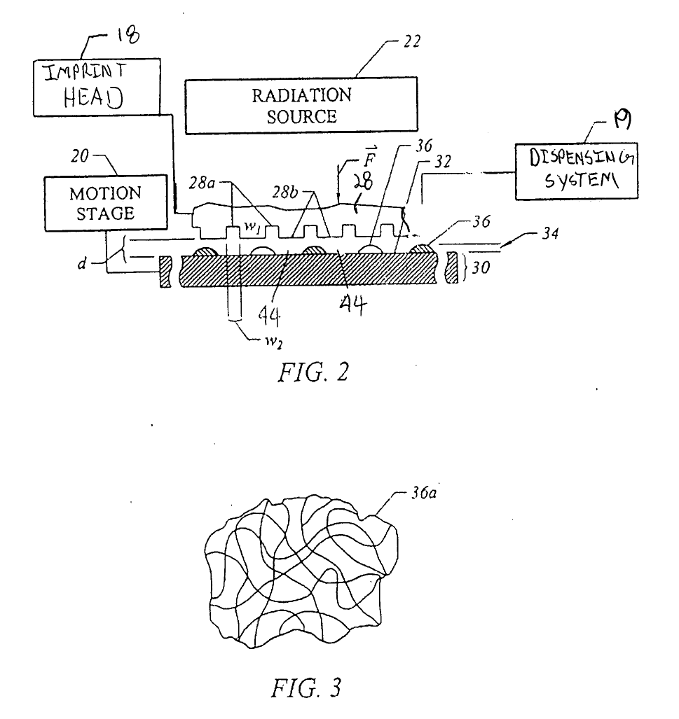

Referring to both FIGS. 1 and 2, connected to imprint head 18, via a chuck 27, is a template 26 having a mold 28 thereon. An exemplary chuck is disclosed in U.S. patent application Ser. No. 10/293,224, entitled “A Chucking System for Modulating Shapes of Substrates” filed Nov. 13, 2003, which is assigned to the assignee of the present invention and incorporated by reference herein. Mold 28 includes a plurality of features defined by a plurality of spaced-apart recessions 28a and protrusions 28b. The plurality of features defines an original pattern that forms the basis of a pattern to be transferred into a substrate 30 positioned on motion stage 20. To that end, imprint head 18 and/or motion stage 20 may vary a distance “d” between mold 28 and substrate 30. In this manner, the features on mold 28 may be imprinted into a flowable region of substrate 30, discussed more fully below. Radiation source 22 is located so that mold 28 is positioned between radiation source 22 and substrate 30. As a result, mold 28 is fabricated from a material that allows it to be substantially transparent to the radiation produced by radiation source 22.

Referring to both FIGS. 2 and 3, a flowable region, such as an imprinting layer 34, is disposed on a portion of a surface 32 that presents a substantially planar profile. A flowable region may be formed using any known technique, such as a hot embossing process disclosed in U.S. Pat. No. 5,772,905, which is incorporated by reference in its entirety herein, or a laser assisted direct imprinting (LADI) process of the type described by Chou et al. in Ultrafast and Direct Imprint of Nanostructures in Silicon, Nature, Col. 417, pp. 835-837, June 2002. In the present embodiment, however, a flowable region consists of imprinting layer 34 being deposited as a plurality of spaced-apart discrete beads 36 of a material 36a on substrate 30, discussed more fully below. An exemplary system for depositing beads 36 is shown as 19, in FIG. 1, and is discussed more fully below with reference to FIG. 7.

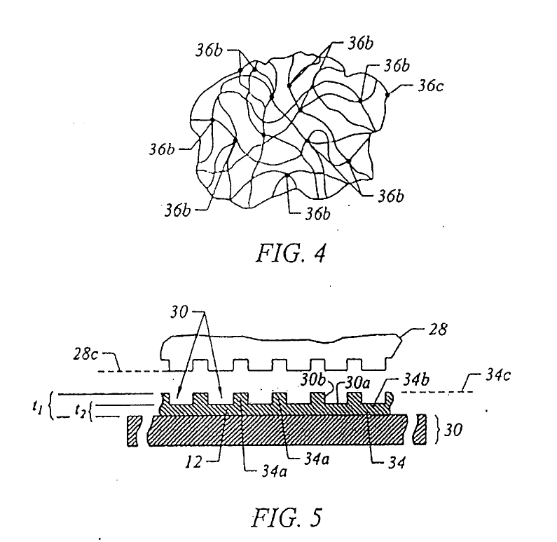

Referring again to FIG. 2, imprinting layer 34 is formed from material 36a that may be selectively polymerized and cross-linked to record the original pattern therein, defining a recorded pattern. An exemplary composition for material 36a is disclosed in U.S. patent application Ser. No. 10/463,396, filed Jun. 16, 2003 and entitled “Method to Reduce Adhesion Between a Conformable Region and a Pattern of a Mold,” which is incorporated by reference in its entirety herein. Material 36a is shown in FIG. 4 as being cross-linked at points 36b, forming a cross-linked polymer material 36c.

Referring to FIGS. 2, 3 and 5, the pattern recorded in imprinting layer 34 is produced, in part, by mechanical contact with mold 28. To that end, distance “d” is reduced to allow imprinting beads 36 to come into mechanical contact with mold 28, spreading beads 36 so as to form imprinting layer 34 with a contiguous formation of material 36a over surface 32. In one embodiment, distance “d” is reduced to allow sub-portions 34a of imprinting layer 34 to ingress into and fill recessions 28a.

To facilitate filling of recessions 28a, material 36a is provided with the requisite properties to completely fill recessions 28a, while covering surface 32 with a contiguous formation of material 36a. In the present embodiment, sub-portions 34b of imprinting layer 34 in superimposition with protrusions 28b remain after the desired, usually minimum, distance “d”, has been reached, leaving sub-portions 34a with a thickness t₁, and sub-portions 34b with a thickness t₂. Thicknesses “t₁” and “t₂” may be any thickness desired, dependent upon the application.

Referring to FIGS. 2, 3 and 4, after a desired distance “d” has been reached, radiation source 22 produces actinic radiation that polymerizes and cross-links material 36a, forming cross-linked polymer material 36c. As a result, the composition of imprinting layer 34 transforms from material 36a to cross-linked polymer material 36c, which is a solid. Specifically, cross-linked polymer material 36c is solidified to provide side 34c of imprinting layer 34 with a shape conforming to a shape of a surface 28c of mold 28, shown more clearly in FIG. 5. After imprinting layer 34 is transformed to consist of cross-linked polymer material 36c, shown in FIG. 4, imprint head 18, shown in FIG. 2, is moved to increase distance “d” so that mold 28 and imprinting layer 34 are spaced-apart.

Referring to FIG. 5, additional processing may be employed to complete the patterning of substrate 30. For example, substrate 30 and imprinting layer 34 may be etched to transfer the pattern of imprinting layer 34 into substrate 30. To facilitate etching, the material from which imprinting layer 34 is formed may be varied to define a relative etch rate with respect to substrate 30, as desired. The relative etch rate of imprinting layer 34 to substrate 30 may be in a range of about 1.5:1 to about 100:1.

Referring to FIGS. 1 and 6 typically, template 26 includes a plurality of molds, shown as 26a, 26b, 26c and 26d, each of which may include a common pattern or differing patterns. Although four molds are shown, any number may be present. Further molds 26a, 26b, 26c and 26d may be arranged, on template 26, as a matrix. Each of molds 26a, 26b, 26c and 26d are separated from an adjacent mold 26a, 26b, 26c and 26d by a recess. As shown a recess 31a is defined between molds 28a and 28b. A recess 31b is defined between molds 28b and 28c, and a recess 31c is defined between molds 28c and 28d. The height, h₁, h₂, and h₃, of each recess 31a, 31b and 31c, respectively, is substantially greater than the depth of recession 28a, shown in FIG. 2. As a result, upon application of the appropriate forces between template 26 and material 36a, material 36a in superimposition with each of molds 28a, 28b, 28c and 28d will not extrude from a region of substrate 30 coextensive with molds 28a, 28b, 28c and 28d. It is believed that this is due in part to capillary attraction between molds 28a, 28b, 28c and 28d and material 36a in superimposition therewith. This allows spreading material 36a to cover an area of substrate 30 that has a desired shape as defined by the shape of molds 28a, 28b, 28c and 28d. For example, the area of substrate 30 over which material 36a may be spread may have any geometric shape known, e.g., circular, polygonal and the like.

Referring to FIGS. 6 and 7, taking advantage of these properties, an imprinting layer 34 may be formed on substrate 30, as a plurality of spaced-apart layer segments, shown as 134a, 134b, 134c and 134d. One or more of layer segments 134a, 134b, 134c and 134d may consist of a composition of material that differs from the composition of material associated with the remaining layer segments 134a, 134b, 134c and 134d. To that end, dispensing system 19 may include a plurality of jet nozzles 50 each of which is in fluid with one or more of a plurality of material reservoirs 52. Material reservoirs 52 contain material to be deposited on substrate 30, such as material 36a or some other material. To deposit differing materials concurrently on substrate, one or more of material reservoirs 52 may contain a composition of material that differs from the composition of material

Referring to FIGS. 1 and 7, an exemplary system implemented as fluid dispensing system 19 is described by Steinerta et al. in “An Improved 24 Channel Picoliter Dispenser Based On Direct Liquid Displacement”, published at The 12th International Conference on Solid State Sensors, Actuators and Microsystems, Boston, Jun. 8-12, 2003. Specifically, by providing material reservoirs 52a 52b 52c and 52d including differing material in a plurality of flowable regions may be formed on substrate 30, concurrently. As shown, the first flowable region includes droplets 234a. The second flowable region includes droplets 234b. A third flowable region includes droplets 234c, and a fourth flowable region includes droplets 234d. This system facilitates formation of a layer of imprinting material on a common substrate containing multiple materials.

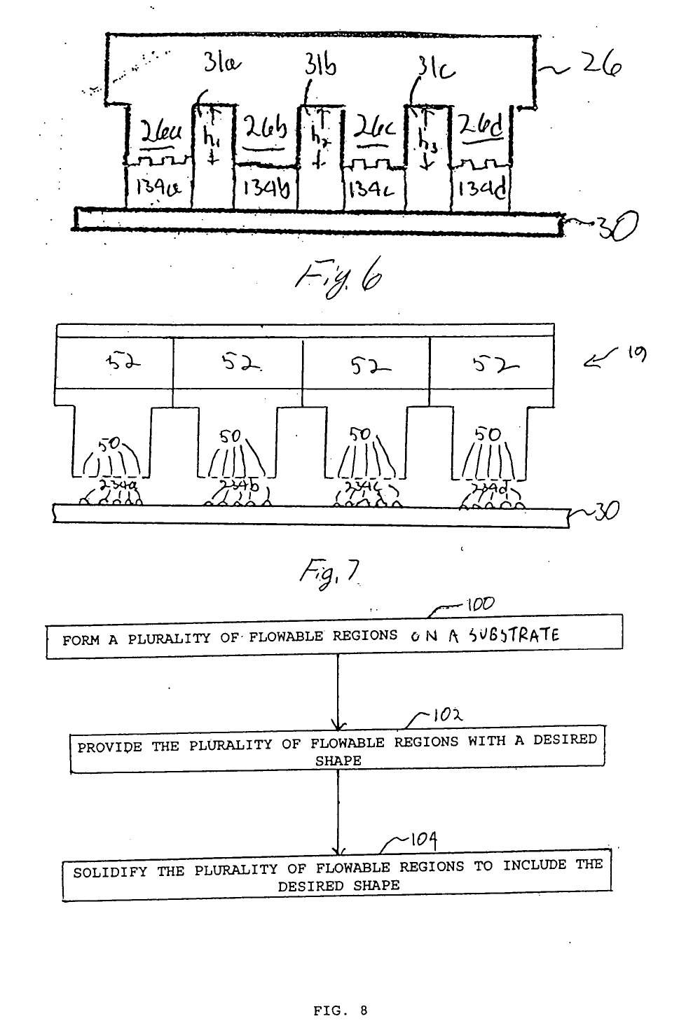

Referring to FIGS. 7 and 8, in operation, a plurality of flowable regions is formed on substrate 30 at step 100. A first subset of the plurality of flowable regions comprises a first composition, and a second subset of the plurality of flowable regions includes a second composition, differing from the first composition. The first and second subsets of the plurality of flowable regions are provided with a surface having a desired shape at step 102. This is typically achieved by contact with molds 28a, 28b, 28c and 28d, as discussed above. Thereafter, at step 104, the first and second subsets of the plurality of flowable regions are solidified, such as by exposure to actinic radiation, as discussed above.

The embodiments of the present invention described above are exemplary. For example, anomalies in processing regions other than film thickness may be determined. For example, distortions in the pattern may formed in imprinting layer may be sensed and the cause of the same determined employing the present invention. As a result, many changes and modifications may be made to the disclosure recited above, while remaining within the scope of the invention. Therefore, the scope of the invention should not be limited by the above description, but instead should be determined with reference to the appended claims along with their full scope of equivalents.

1. A method of forming a layer on a substrate, comprising:
forming a plurality of flowable regions on said substrate, with a first subset of said plurality of flowable regions comprising a first composition and a second subset of said plurality of flowable regions including a second composition differing from said first composition;
providing said first and second subsets of said plurality of flowable regions with a surface having a desired shape; and
solidifying said first and second subsets of said plurality of flowable regions.

2. The method as recited in claim 1 wherein providing further includes forming a surface of the flowable regions of said first and second subset with a desired shape.

3. The method as recited in claim 1 wherein providing further includes spreading the flowable region to cover an area of said substrate, with said area having said desired shape.

4. The method as recited in claim 1 wherein providing further includes generating said desired shape in said first subset of said plurality of flowable regions concurrently with generating said desired shape in said second subset of said plurality of flowable regions.

5. The method as recited in claim 1 wherein providing further includes generating said desired shape in said first subset of said plurality of flowable regions concurrently with generating said desired shape in said second subset of said plurality of flowable regions, with said desired shape associated with said first subset differing from said desired shape associated with said second subset.

6. The method as recited in claim 1 wherein forming further includes forming each of said plurality of flowable regions to be spaced-apart from adjacent flowable regions of said plurality of flowable regions.

7. The method as recited in claim 1 wherein forming further includes depositing a plurality of fluid droplets on said substrate, with a first subset of said plurality of fluid droplets comprising a first composition and a second subset of said plurality of fluid droplets regions including a second composition differing from said first composition.

8. The method as recited in claim 1 wherein forming further includes ablating multiple regions of said substrate to effectuate a phase state change therein from solid to a fluid.

9. The method as recited in claim 1 wherein forming further includes forming said plurality of flowable regions concurrently.

10. The method as recited in claim 1 wherein providing further includes contacting said first and second flowable regions with mold.

11. The method as recited in claim 1 further including spreading material in said first and second flowable regions over said substrate while confining the material associated with said first flowable region to a first area and confining the flowable material associate with said second flowable region to a second area, with said first and second areas being spaced-apart.

12. The method as recited in claim 1 wherein providing further includes placing a mold proximate to said first and second flowable regions and compressing said first and second flowable regions between said mold and said substrate to spread material in said first flowable region over a first area of said substrate and spread material in said second flowable regions over a second area of said substrate with the material in said first area being confined thereto via capillary attraction between said mold and said substrate and the material in said second area being confined thereto via capillary forces between said mold and said substrate, with said first and second areas being spaced-apart.

13. The method as recited in claim 1 wherein providing further includes placing a mold proximate to said first and second subsets of said plurality of flowable regions and applying an electromagnetic field to said first and second subsets of said plurality of flowable regions.

14. A method of forming a layer on a substrate, comprising:
forming a plurality of spaced-apart droplets of material on said substrate, with a subset of said plurality of spaced-apart droplets containing a material composition that differs from the material composition associated with the remaining spaced-apart droplets of said plurality of spaced-apart droplets;
concurrently providing said plurality of spaced apart droplets with a desired shape; and
solidifying said plurality of spaced-apart droplets.

15. The method as recited in claim 14 wherein providing further includes generating said desired shape in said subset of said plurality of spaced-apart droplets concurrently with generating said desired shape in the remaining droplets of said plurality of spaced-apart droplets.

16. The method as recited in claim 14 wherein providing further includes generating said desired shape in said subset of said plurality of spaced-apart droplets concurrently with said desired shape in the remaining droplets of said plurality of spaced-apart droplets, with said desired shape associated with said subset differing from said desired shape associated with the remaining droplets of said plurality of spaced-apart droplets.

17. The method as recited in claim 14 wherein providing further includes contacting said plurality of spaced-apart droplets with a mold.

18. The method as recited in claim 14 further spreading said plurality of spaced-apart droplets over said substrate while confining the material associated with said subset to a first area and confining the flowable material associate with the remaining droplets of said plurality of droplets to a second area, with said first and second areas being spaced-apart.

19. The method as recited in claim 18 wherein spreading further includes compressing said plurality of spaced-apart droplets between said mold and said substrate to spread material in said subset over a first area of said substrate and spread material in the remaining droplets of said plurality of spaced apart droplets over a second area of said substrate with the material in said first area being confined thereto via capillary attraction between said mold and said substrate and the material in said second area being confined thereto via capillary forces between said mold and said substrate, with said first and second areas being spaced-apart.

20. The method as recited in claim 14 wherein providing further includes placing a mold proximate to said plurality of spaced-apart droplets and applying an electromagnetic field to said first and second subsets of said plurality of flowable regions.

21. A method of forming a layer on a substrate, comprising:
forming a plurality of spaced-apart droplets of material on said substrate, with a subset of said plurality of spaced-apart droplets containing a material composition that differs from the material composition associated with the remaining spaced-apart droplets of said plurality of spaced-apart droplets;
providing said plurality of spaced apart droplets with a desired shape by placing a mold proximate to said plurality of spaced-apart droplets spread said plurality of spaced-apart droplets over said substrate while confining the material associated with said subset to a first area and confining the flowable material associated with the remaining droplets of said plurality of droplets to a second area, with said first and second areas being spaced-apart; and
solidifying said plurality of spaced-apart droplets.

22. The method as recited in claim 21 wherein said desired shape associated with said subset differs from said desired shape associated with the remaining droplets of said plurality of spaced-apart droplets.

23. The method as recited in claim 21 wherein providing further includes contacting said plurality of spaced-apart droplets with a mold.

24. The method as recited in claim 21 wherein forming further includes forming said plurality of spaced-apart droplets of material concurrently on said substrate.

25. The method as recited in claim 21 wherein providing further includes concurrently providing said plurality of spaced-apart droplets with said desired shape.

26. The method as recited in claim 21 further including compressing said plurality of spaced-apart droplets between said mold and said substrate to spread material in said subset over a first area of said substrate and spread material in the remaining droplets of said plurality of spaced apart droplets over a second area of said substrate with the material in said first area being confined thereto via capillary attraction between said mold and said substrate and the material in said second area being confined thereto via capillary forces between said mold and said substrate, with said first and second areas being spaced-apart.

27. The method as recited in claim 21 wherein providing further includes placing a mold proximate to said plurality of spaced-apart droplets and applying an electromagnetic field to said first and second subsets of said plurality of flowable regions.
